(19) United States
(12) Patent Application Publication
(10) Pub. No.: US 2002/0153991 A1
(43) Pub. Date: Oct. 24, 2002

(54) Overload protection unit

(76) Inventors: Michael Haeusel, Hoigerloch (DE); Frank Reschnar, Illsfeld (DE)

Correspondence Address: Striker Striker & Stenby, 103 East Neck Road, Huntington, NY, 11743, US

(21) Appl. No.: 10/089,675

(22) PCT Filed: Jun. 26, 2001
(86) PCT No.: PCT/DE01/02353

(30) Foreign Application Priority Data
Sep. 7, 2000 (DE) 100 44 081.9

(51) Int. Cl. H01H 37/76

(52) U.S. Cl. 337/404; 337/405; 337/401

(57) ABSTRACT

The invention relates to an overload protector, in particular for the starter of an internal combustion engine, having a first contact (1), which in a non-tripped state of the overload protector is connected electrically conductively to a second contact (2) by the action of a material (3), and a temperature-caused deformation and/or change in the material (3) for tripping the overload protector brings about an interruption in the electrical connection between the first contact (1) and the second contact (2) if a predetermined temperature value of the material (3) is exceeded.

According to the invention, the material is solder (3).

The present invention also relates to an electrical machine that has the overload protector of the invention and to the use of a soldered point as the overload protector.

The present invention relates to an overload protector, in particular for the starter of an internal combustion engine, having a first contact, which in a non-tripped state of the overload protector is connected electrically conductively to a second contact by the action of a material, and a temperature-caused deformation and/or change in the material for tripping the overload protector brings about an interruption in the electrical connection between the first contact and the second contact if a predetermined temperature value of the material is exceeded.

### PRIOR ART

One such overload protector is known in the form of a fuse, for instance, in which the first contact and the second contact are connected by a wire. If a predetermined electrical current intensity is exceeded, the wire melts, and got the electrical current circuit is broken. The maximum allowable electrical current intensity is determined by the choice of the material comprising the wire and by the cross section of the wire. In an overload protector in the form of a fuse, the physical variable monitored is therefore the electrical current intensity.

So-called bimetallic switches are also known. Bimetallic switches have an element comprising at least two different metals, which deforms as a function of the ambient temperature. The element comprising the at least two different metals is disposed between the first contact and the second contact in such a way that in the non-tripped state of the overload protector, it electrically connects these contacts. If the ambient temperature exceeds a predetermined value, the element comprising the at least two different metals deforms in such a way that the electrical connection between the first contact and the second contact is broken. In bimetallic switches, the physical variable monitored is therefore the ambient temperature.

If monitoring of the ambient temperature or of the temperature of devices or components of devices is omitted, problems can arise in many cases.

Such problems can occur for instance in a starter for an internal combustion engine. For starting the engine, such a starter has to turn the engine at a minimum rpm, called the starting rpm, so that even under unfavorable operating conditions the air-fuel mixture required in an Otto engine for it to run on its own can be formed, or in a Diesel engine so that the self-ignition temperature can be reached. Moreover, after the first few ignitions, the starter has to support the engine as it runs up to the minimum independent operating rpm of the engine. If a starter becomes overloaded, in unfavorable cases overheating can lead to short circuits with arcs, and can finally lead to fires. For instance, if a contact bridge of the starter relay is welded to the contact bolt, the starter rotates during idling without being further triggered. As a result, the starter commutator overheats, and it can happen that because of the high centrifugal forces, the commutator laminations can no longer be held together in the package. This so-called spinout of the laminations can lead to the destruction of surrounding component groups, which can lead to undefined short circuits that in turn can cause fires. Moreover, operation at certain load points for an overly long time can lead to overheating of the starter. Because of the high temperature, plastics, resins, greases and oils in the starter can outgas, and an ignitable gas-air mixture can be formed. The commutator laminations gradually come loose from the package and file down the carbon brushes. Between the brushes and the irregular lamination travel path, greater spacings occur, and as a result the brush fire can be converted into arcs. This can lead to temperatures of over 1000° C., which once again can cause a fire or the ignition of the ignitable gas-air mixture.

### ADVANTAGES OF THE INVENTION

Because the material of the overload protector of the invention is solder, and because a soldered point is used as an overload protector, dangerous operating states are effectively averted in many cases.

In a simple embodiment of the present invention, the first contact and the second contact are spaced apart from one another. In this embodiment, in the non-tripped state of the overload protector the solder electrically connects the first contact and the second contact. If a certain ambient temperature, which can be defined by the choice of the solder used, is exceeded then the solder melts, and the electrical connection is broken.

In a further embodiment of the present invention, it is provided that the first contact and the second contact contact one another when they are electrically conductively connected. In this case, in the non-tripped state of the overload protector, the solder can take over the function of a conventional soldered point or welded connection.

Especially if the first contact and the second contact contact one another when they are electrically conductively connected, it is advantageous if acting on the first contact and/or on the second contact is a force that is oriented away from the respective other contact. If the predetermined temperature of the solder is exceeded, the solder melts, and the first contact and second contact are moved away from one another by the effect of the force, so that the electrical connection between the first contact and the second contact is broken. In the simplest case, the force that causes the first contact and second contact to move apart is formed by the force of gravity.

However, it can also be advantageous if this force is generated by a spring element. A spiral spring, leaf spring or any other suitable spring can be used as the spring element. To prevent unwanted tripping of the overload protector, however, the spring element should be designed such that the spring force generated by the spring element is not so great that a mechanical deformation of the solder causes the electrical connection between the first contact and the second contact to be broken even though in the non-tripped state the overload protector actually connects them.

In many cases, and especially in more-complicated embodiments of the present invention, it is advantageous if the first contact and/or the second contact is movably supported. A movable support of the first and/or second contact can advantageously be combined with the provision of a spring element. The bearing or bearings or joints can either engage the first and/or second contact directly or can engage some element that carries these contacts. The bearing or bearings are preferably designed such that to trip the overload protector, they enable a motion of the first contact and second contact oriented away from one another, for instance by tilting away or rotating away from one another.

In certain embodiments of the present invention it is provided that the solder is directly in contact with the first contact and/or the second contact when the first contact and the second contact are electrically conductively connected. In such embodiments, in the non-tripped state of the overload protector the solder additionally serves as a conventional soldered point, which is known to reduce the transition resistance between the first contact and the second contact.

The present invention also includes embodiments in which the first contact is disposed on a first arm, and/or in which the second contact is disposed on a second arm. The first arm and/or the second arm are then preferably at least partly made of an electrically nonconductive material.

Particularly in that case, it can be provided that the first arm and/or the second arm, in the non-tripped state of the overload protector, are kept by the action of the solder in a position in which the first contact and the second contact are electrically connected. Embodiments in which the solder is in direct contact with the first and/or the second contact are possible, as are embodiments in which the solder is in contact with the first and/or the second arm.

One embodiment of the present invention provides that a first element is associated with the first arm; that a second element is associated with the second arm; and that the first element and/or the second element, in the non-tripped state of the overload protector, is kept by the action of the solder in a position in which the first contact and the second contact are electrically connected. If the solder is in direct contact with the first element and/or the second element, then as a result it is possible for instance to adapt the tripping characteristic of the overload protector to the particular kind of use. In other words, the basic design of the overload protector can remain the same for many applications, while the tripping characteristic is defined by the choice of the first and second elements that are connected by a suitable solder.

Preferably, the first element and the second element are replaceable. As a result, after the overload protector has been tripped, there is no need to replace the entire overload protector simply to reestablish the electrical connection between the first contact and the second contact.

In one embodiment of the present invention, it is also provided that a first line is welded to the first contact, and/or that a second line is welded to the second contact. Welding lines, which is known per se, is advantageous because a welded connection is capable of withstanding much higher temperatures than a soldered connection. In conjunction with starters for internal combustion engines, for instance, it is usual to provide welded connections in the region of the commutator, which acts as a heat source, and these connections can then withstand the high temperatures that prevail there. With respect to the present invention, the advantage is thus obtained that the current circuit is opened at a defined point by the tripping of the overload protector.

In certain embodiments of the present invention it may be provided that the first arm has a first opening, through which the first line extends, and/or that the second arm has a second opening, through which the second line extends. This embodiment is especially attractive if the first contact and/or the second contact is disposed in the region of these openings, for instance on the inside of the corresponding arms.

The solder used according to the invention is preferably a soft solder. This soft solder can for instance be the soft solder known as Sn60Pb. In general, by the choice of solder, or its melting temperature, the temperature at which the overload protector trips is defined. However, in this respect it should be noted that even upon a sudden rise in the ambient temperature, the solder itself does not reach its melting temperature until after a warmup phase. The length of this transitional phase is therefore a measure for the inertia of the overload protector, and the length of this phase can be varied, for instance by means of the quantity of solder employed. Especially in conjunction with starters for internal combustion engines, it is advantageous if the overload protector does not trip too fast, since in many cases it is acceptable if the allowable temperature is briefly exceeded.

In certain embodiments of the present invention it can be provided that the overload protector trips at approximately 320° C. For instance in conjunction with starters for internal combustion engines, this temperature can correspond to a limit value beyond which it can be expected that the critical states described at the outset will ensue.

As noted, the overload protector of the invention can especially advantageously be employed in conjunction with electrical machines, and therefore the present invention also relates to an electrical machine that has the overload protector according to the invention. As already noted, this electrical machine can for instance be embodied by a starter for an internal combustion engine, or a starter-generator.

Since in many cases the commutator of the electrical machine represents its strongest heat source, the overload protector is preferably disposed in the region of this commutator. However, other positions are also conceivable, since the tripping temperature of the overload protector can be adapted by the choice of a suitable solder.

One embodiment of the present invention relates to an electrical machine, in which the overload protector is disposed on a brush plate, which has brushes that cooperate with the commutator. This embodiment has the advantage that the brush plates no longer need to be welded directly to the field winding. This is because depending on the embodiment, the solder of the overload protector of the invention can make the connection between the field winding and the brush plate. Since in this case a separable connection is involved, it is possible to replace the brush plate for the sake of repair, maintenance or testing.

In one embodiment of the present invention, it is provided that the brushes include positive brushes, and that the overload protector is disposed at a connection bracket to which a power supply is connected that supplies the positive brushes. This embodiment has the advantage that the entire brush apparatus becomes voltage-free if the overload protector trips.

Although this is not intended as a restriction of any kind, the electrical machine of the invention may be a starter for an internal combustion engine, or a starter-generator.

Regardless of the special embodiment, the present invention pertains to the use of a soldered point as an overload protector.

### DRAWING

The invention will be described in further detail below in conjunction with the drawings.

Shown are:

FIG. 1, a first, simple embodiment of the overload protector of the invention, in the non-tripped state;

FIG. 2, the overload protector of FIG. 1 in the tripped state;

FIG. 3, a second embodiment of the overload protector of the invention in the non-tripped state;

FIG. 4, a third embodiment of the overload protector of the invention in the non-tripped state;

FIG. 5, a fourth embodiment of the overload protector of the invention in the non-tripped state;

FIG. 6, the overload protector of FIG. 5 in the tripped state;

FIG. 7, a fifth embodiment of the overload protector of the invention in the non-tripped state;

FIG. 8, the overload protector of FIG. 7 in the tripped state;

FIG. 9, a seventh embodiment of the overload protector of the invention in the non-tripped state;

FIG. 10, the overload protector of FIG. 9 in the tripped state;

FIG. 11, a graph that illustrates the relationship of the voltage, current, brush temperature and retaining bracket temperature of a starter in the idling mode; and

FIG. 12, a graph that illustrates the relationship of the voltage, current, brush temperature and retaining bracket temperature of a starter in operation under load.

### DESCRIPTION OF EXEMPLARY EMBODIMENTS

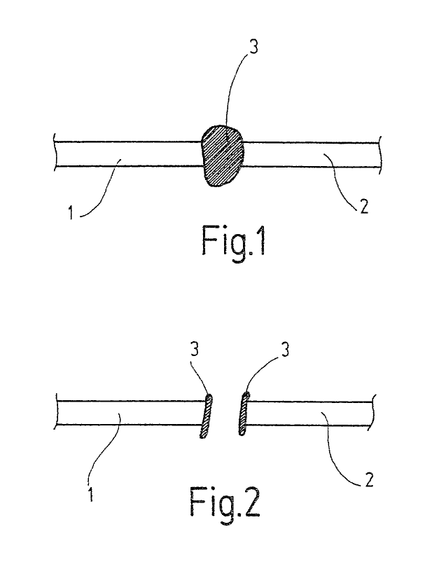

In FIGS. 1 and 2, a first, simple exemplary embodiment of the overload protector of the invention is shown; the overload protector is shown in FIG. 1 in the non-tripped state and in FIG. 2 in the tripped state. In FIG. 1, a first contact 1 and a second contact 2 are shown schematically; the first contact 1 and second contact 2 are spaced apart from one another. In the non-tripped state, shown in FIG. 1, of the overload protector, the solder 3, which can for instance be a soft solder, electrically conductively connects the first contact 1 to the second contact 2. If the temperature of the first contact 1 or of the second contact 2 and/or the ambient temperature exceeds a certain value because of an overload state, then the solder 3 reaches its melting temperature, and the melting process begins. In the simplest case, the liquid solder 3 simply drips downward, breaking the electrical connection between the first contact and the second contact 2. The overload protector of the invention is preferably used in an environment in which typically there are no conventional soldered points, or the solder used for conventional soldered points has a markedly higher melting temperature than that of the solder 3. The connection of the first contact 1 and/or second contact 2 to lines, not shown in FIGS. 1 and 2, can be done for instance by welding. As a result, it can be assured that these connections will not break even at high temperatures.

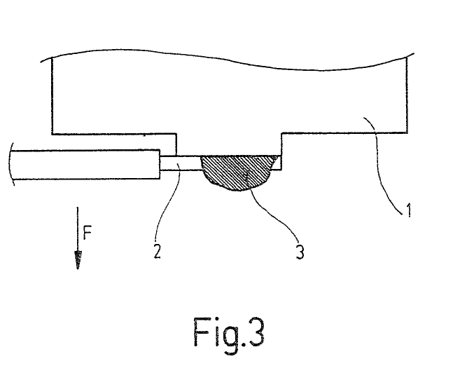

FIG. 3 shows a second embodiment of the overload protector of the invention. A second contact 2, disposed below a first contact 1, is electrically conductively connected to the first contact 1 via solder 3. In this embodiment, the first contact 1 and second contact 2, in the non-tripped state of the overload protector, preferably contact one another, on the order of a conventional soldered point. Acting on the second contact 2, which can for instance be formed by a stranded conductor, is the force of gravity F, shown schematically, or in other words, because of the spatial disposition of the first contact 1 and second contact 2, a force that is oriented away from the first contact 1. A temperature increase associated with an overload state heats the solder 3 up to its melting temperature, and the second contact 2 is moved downward by the force of gravity, so that the electrical connection between the first contact 1 and the second contact 2 is broken.

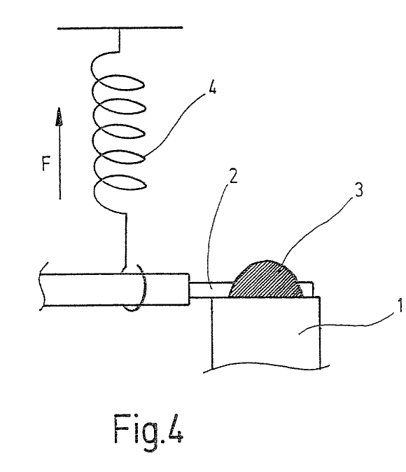

FIG. 4 shows a schematic illustration of a third embodiment of the overload protector of the invention. A first contact 1 is electrically conductively connected to a second contact 2, which is shown in the form of a stranded conductor, by means of solder 3. In this embodiment as well, the first contact 1 and the second contact 2 contact one another when they are electrically conductively connected, or in other words when the overload protector is in its non-tripped state. A force F that is oriented away from the first contact 1 acts on the second contact 2. In the exemplary embodiment shown in FIG. 4, the force F is generated by a spring element 4. The spring element 4 is shown as a spiral spring in FIG. 4. However, other suitable spring elements can be used, such as a leaf spring or a torsion spring. In making the choice of the spring element 4, care must be taken that the spring force F selected not be too high; otherwise, improper tripping of the overload protector caused by breakage of the unmelted solder 3 could occur. As soon as the solder 3 has reached its melting temperature, the second contact 2 is moved upward by the action of the spring force F, and the electrical connection between the first contact 1 and the second contact 2 is interrupted.

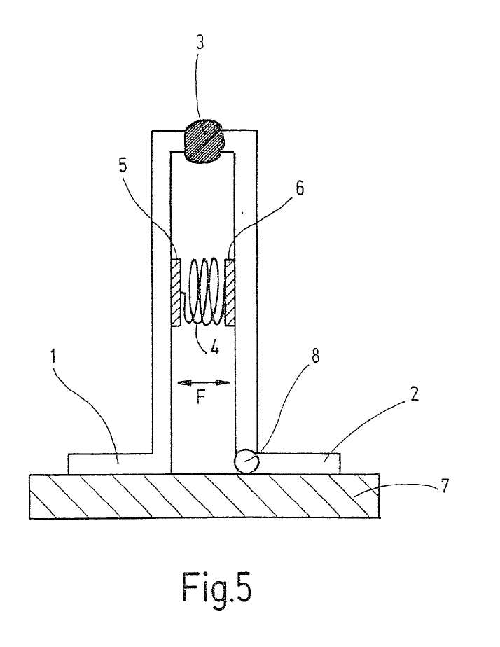

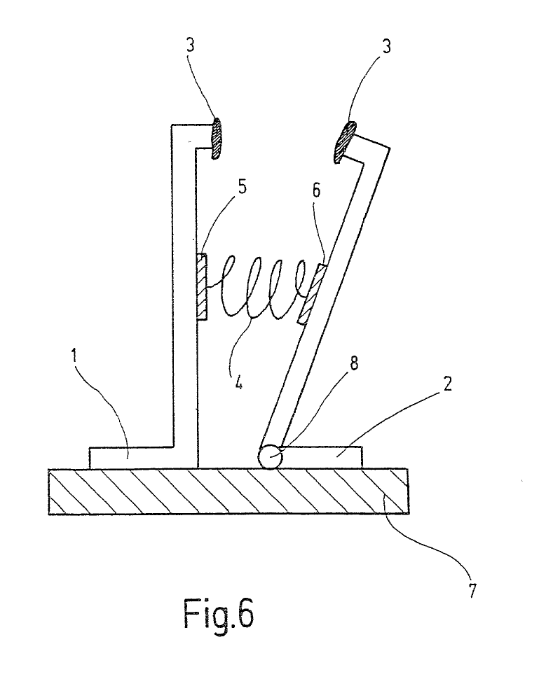

FIG. 5 shows a fourth embodiment of the overload protector of the invention in the non-tripped state. An essentially L-shaped first contact 1 is disposed on insulator material 7. The free end of the long leg of the L is bent again at the end and is electrically conductively connected by solder 3 to the also-bent free end of a further long leg of an L that is associated with a second contact 2. The further long leg of the L of the second contact 2 is connected via a joint 8 to a further short leg of an L, which is also associated with the second contact 2. The second contact 2, or its long leg of the L is therefore supported movably; a motion of the long leg of the L of the second contact 2 in the non-tripped state of the overload protector is avoided, however, because of the action of the solder 3. In the exemplary embodiment shown in FIG. 5, a spring element 4 is provided between the first contact 1 and the second contact 2; on the first contact 1 and the second contact 2, it exerts a force F that is oriented away from the respective other contact. In the exemplary embodiment shown in FIG. 5, the spring element 4, shown as a spiral spring, does not rest directly on the first contact 1 or on the second contact 2 but instead, insulators 5, 6 are provided between the respective end of the spring and the corresponding contact and prevent the first contact 1 from being electrically connected to the second contact 2 via the spring element 4. FIG. 6 shows the overload protector of FIG. 5 in the tripped state. Once the solder 3 has been heated to its melting temperature because of an overload state, the further, long leg of the L of the second contact 2 flips to the right in terms of FIG. 6. The motion of the further long leg of the L of the second contact 2 was brought about the spring element 4; in the view of FIG. 6, the overload protector is in a state of force equilibrium. The embodiment of FIGS. 5 and 6 offers the advantage in particular that conductors, not shown in the drawings, can be connected to the two short legs of the L, for instance by welding, so that these conductors, not shown, are not moved even if the overload protector is tripped. The embodiment shown in FIGS. 5 and 6 is also fundamentally suitable for being secured by something like an SMD technique. To that end, the element 7 would have appropriate contact points on its surface, and the short legs of the L of the first contact 1 and of the second contact 2 would be connected, for instance welded, to these contact faces.

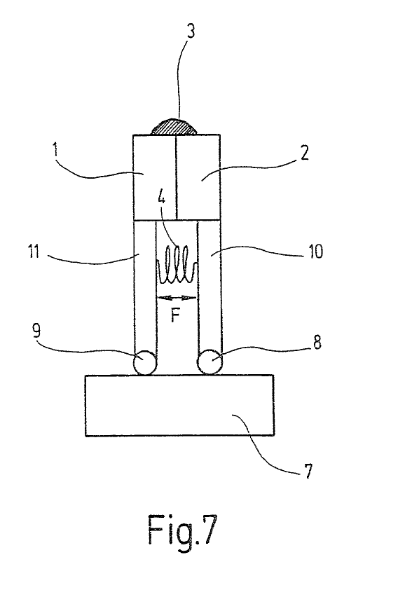

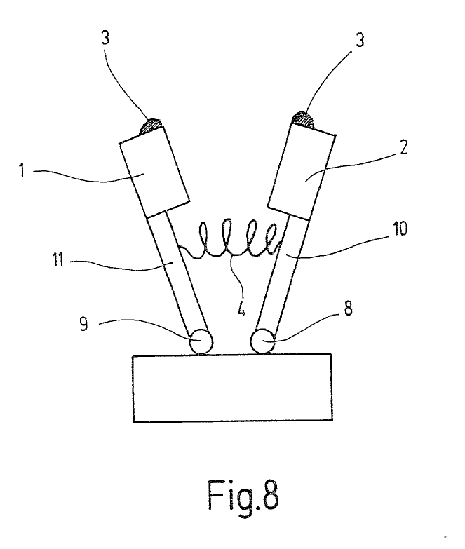

FIG. 7 shows a fifth embodiment of the overload protector of the invention in the non-tripped state, while FIG. 8 shows the overload protector of FIG. 7 in the tripped state. In the fifth embodiment of the overload protector of the invention, a first contact 1 is secured to a first arm 11, which in the embodiment shown is made from an electrically nonconductive material. Similarly, a second contact 2 is secured to a second arm 10, which is likewise made from an electrically nonconductive material. In the non-tripped state, shown in FIG. 7, of the overload protector the first contact 1 and the second contact 2 rest on one another over a large area, so that they are electrically conductively connected. Solder 3 also contributes to this electrically conductive connection, but primarily it is intended for maintaining the mutual position of the first arm 11 and second arm 10, and of the first contact 1 and second contact 2, in the non-tripped state of the overload protector. The first arm 11 is pivotably disposed on a suitable material 7 via a joint 9. Similarly, the second arm 10 is supported on the material 7 via a second joint 8. Disposed between the first arm 11 and the second arm 10 is a spring element 4 in the form of a spiral spring, which exerts a force F on the first arm 11 and thus on the first contact 1 as well as on the second arm 10 and thus on the second contact 2 that is oriented away from the respective other contact. Since in this embodiment the first arm 11 and the second arm 10 are made from electrically nonconductive material, the spring element 4 can engage the first arm 11 and the second arm 10 directly; in other words, no insulation is required. In the non-tripped state, a motion oriented away from one another of the first arm 11 and thus of the first contact 1 as well as of the second arm 10 and thus of the second contact 2 is prevented by the action of the solder 3. However, as soon as the solder 3 reaches its melting temperature as a result of an overload state, the first arm 11 and thus the first contact 1 and the second arm 10 and thus the second contact 2 move into the position shown in FIG. 8, in which the electrical connection between the first contact 1 and the second contact 2 is interrupted.

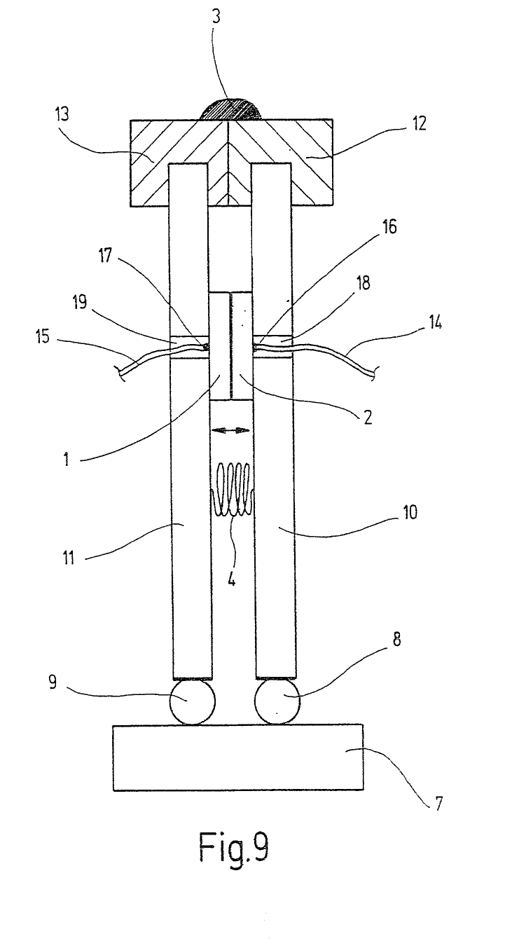

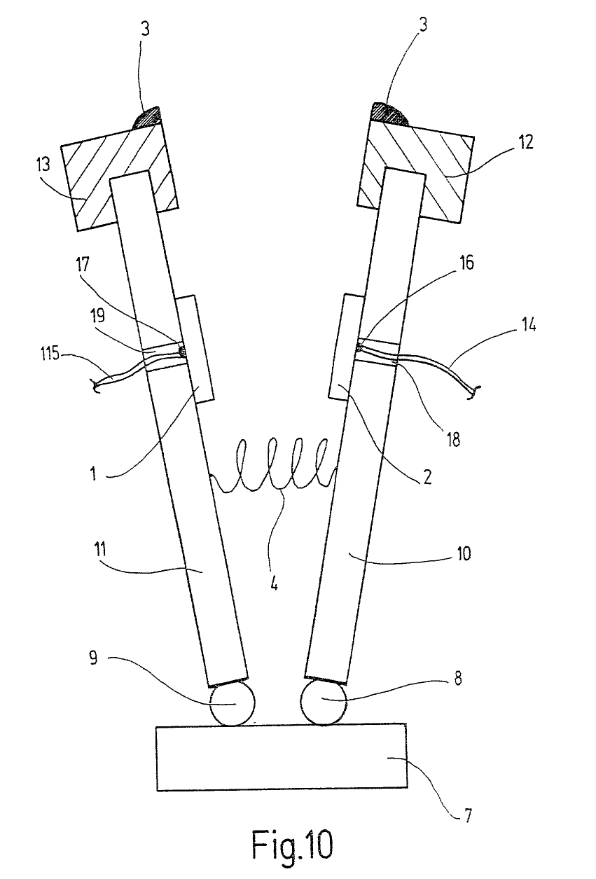

FIG. 9 shows a seventh embodiment of the overload protector of the invention in the non-tripped state, while FIG. 10 shows the overload protector of FIG. 9 in the tripped state. The embodiments of the overload protector of the invention shown in FIGS. 1-8 have a relatively simple design, and the production costs are therefore comparatively low. However, in the embodiments of FIGS. 1-8, after the overload protector has been tripped, either the entire overload protector must be replaced, or optionally, once the first contact 1 and the second contact 2 have been put in an appropriate position, solder 3 must be re-applied, if the electrical connection between the first contact 1 and the second contact 2 is to be restored. The embodiment of the overload protector of the invention shown in FIGS. 9 and 10 has the advantage over the aforementioned embodiments that only some components or only one component of the overload protector has to be replaced in order to re-connect the first contact 1 to the second contact 2 electrically after the overload protector has been tripped. The overload protector in the seventh embodiment of the present invention has a first arm 11 of an electrically nonconductive material, to which a first contact 1 is secured. Correspondingly, a second arm 10 of electrically nonconductive material has a second contact 2. In the non-tripped state, shown in FIG. 9, of the overload protector the first contact 1 and the second contact 2 contact one another in such a way that they are electrically conductively connected. In the region of the first contact 1, the first arm 11 has an opening 19, which exposes part of the back side of the first contact 1. In this portion of the first contact 1, a first conductor 15, shown only schematically, is secured to the first contact 1 via a welded connection 17. Similarly, the second arm 10 has an opening 18 in the region of the second contact 2 that exposes part of the back side of the second contact 2. A second conductor 14, shown only schematically, extends through the opening 18 and is electrically conductively connected to the second contact 2 via a welded connection 16. The first arm 11 and the second arm 10 are connected via suitable bearings 8, 9 to a suitable carrier material 7. Between the first arm 11 and the second arm 10, there is a spring element 4 which exerts a force F oriented away from the respective other contact on the first arm 11 and thus the first contact 1 and on the second arm 10 and thus the second contact 2. In the non-tripped state, the overload protector is kept in the position shown in FIG. 9 by the action of solder 3. The solder connects a first element 13 to a second element 12. The first element 13 and the second element 12 are separably connected to the first arm 11 and the second arm 10 by positive and/or nonpositive engagement. As soon as the solder 3 is heated to its melting temperature because of an overload state, the overload protector in the seventh embodiment assumes the position shown in FIG. 10. In this position, the first arm 11 is tilted to the left, in terms of 20, FIG. 10, around the bearing 9, while the second arm 10 is tilted to the right around the bearing 8. This motion of the first arm 10 and the second arm 11 is brought about by the force generated by the spring element 4. In the seventh embodiment of the present invention, after the overload protector has been tripped the first element 13 and the second element 12 are removed from the first arm 11 and the second arm 10, respectively, in order to restore the electrical connection between the first contact 1 and the second contact 2. After that, the first arm 11 and the second arm 10 are pressed together, counter to the spring force generated by the spring element 4, in such a way that an electrical connection again exists between the first contact 1 and the second contact 2. In this position, a new combination of a new first element 13 and a second element 12 connected to this first element 13 via solder 3 is substituted. The seventh embodiment of the overload protector of the present invention, shown in FIGS. 9 and 10, has the further advantage that the temperature at which the overload protector trips can be adapted in a simple way, by using a combination of the first element 13, second element 12 and solder 3 in which the solder 3 has a suitable melting point.

As noted, and without limiting the invention, the overload protector of the invention can especially advantageously be used with an electrical machine, in particular a starter or a starter-generator of an internal combustion engine. In such electrical machines, even in normal operation such high temperatures are generated that typically welded connections are provided instead of soldered connections in order to perform the appropriate contacting actions.

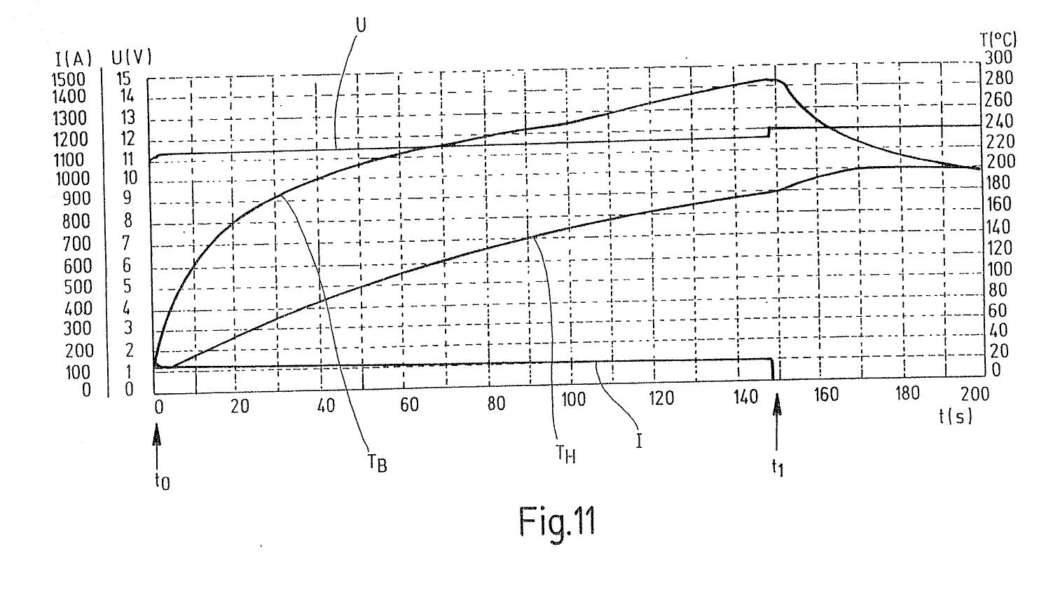

FIG. 11 illustrates the relationship among the supply voltage U, current intensity I, brush temperature T_{b} and retaining bracket temperature Tₕ of a starter that is operated in the idling mode, the solder being formed by soft solder Sn60Pb. For plotting the characteristic curves, an overload switch corresponding essentially to the embodiment shown in FIGS. 5 and 6 was placed in the region of a commutator on a brush plate that carries the brushes that cooperate with the commutator. In particular, the overload protector was placed on a connection bracket to which a power supply is connected that supplies positive brushes; this has the advantage that if the overload protector trips, the entire brush apparatus becomes free of voltage. FIG. 11 shows that in the idling mode of the starter, the supply voltage U drops to approximately 11.4 V, and the starter draws a current of approximately 100 A. Beginning at an ambient temperature of approximately 20° C. at time to, the brush temperature T_{b} and the retaining bracket temperature Tₕ increase over time. At time t₁˜148 seconds, the overload protector trips, because the solder has heated to its melting temperature. Upon the tripping of the overload protector, the current circuit is broken, as can be seen from the course of the current I. At the same time, the supply voltage U increases to the idling voltage of 12 V. The brush temperature T_{b}, which at this time t₁ has already reached a value of over 280° C., rapidly drops after the overload protector has tripped, with the overall result that a critical state can be avoided.

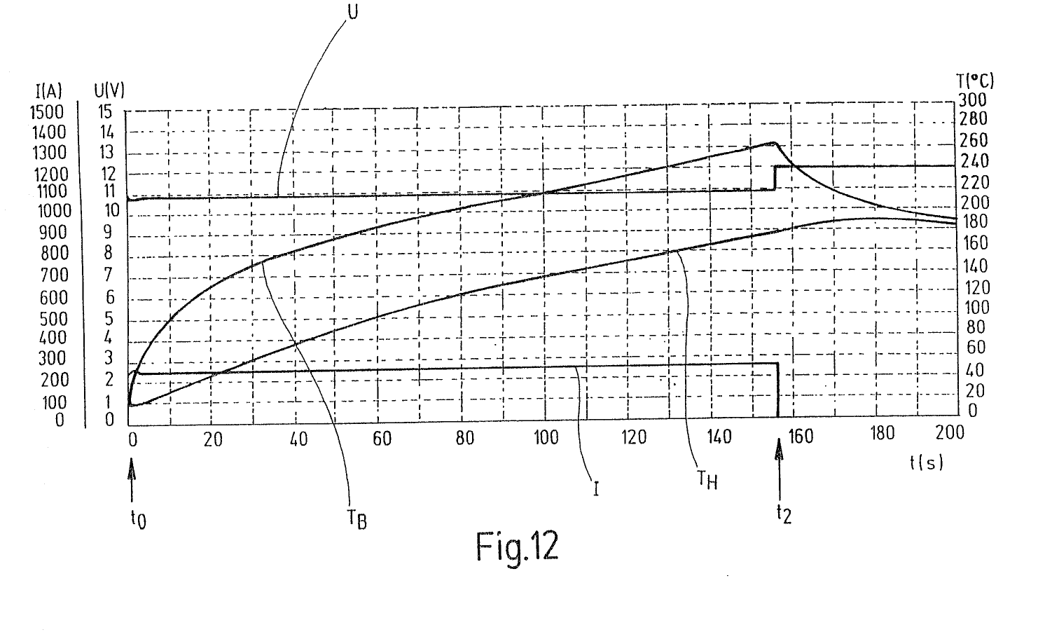

FIG. 12 likewise illustrates the relationship of the supply voltage, current intensity, brush temperature and retaining bracket temperature of a starter, but one which is operated under load, at a current consumption of 250 A. Once again, the solder is formed by soft solder Sn60Pb. For plotting the characteristic curves, an overload protector structurally identical to that used to plot the characteristic curves of FIG. 11 was used. The placement of the overload protector was also the same. From FIG. 12 it can be seen that at the load conditions of the starter cited, the supply voltage U drops to approximately 10.8 V, and the starter draws the aforementioned current of approximately 250 A. Beginning at an ambient temperature of approximately 20° C. at time t₀, the brush temperature T_{b} and the retaining bracket temperature Tₕ increase over time. At time t₂˜156 seconds, the overload protector trips, because the solder has heated to its melting temperature. Upon the tripping of the overload protector, the current circuit is broken, as can be seen from the course of the current I. At the same time, the supply voltage U increases to the idling voltage of 12 V. The brush temperature T_{b}, which at this time t₂ has already reached a value of over 260° C., rapidly drops after the overload protector has tripped, with the overall result that a critical state can be avoided.

From the above it can be seen that the present invention provides for the use of a soldered point, known per se, as an overload protector.

The above description of the exemplary embodiments of the present invention is intended solely for purposes of illustration and not for the sake of limiting the invention. Within the scope of the invention, various changes and modifications can be made without departing from the scope of the invention or its equivalents.

1. An overload protector, in particular for the starter of an internal combustion engine, having a first contact (1), which in a non-tripped state of the overload protector is connected electrically conductively to a second contact (2) by the action of a material (3), and a temperature-caused deformation and/or change in the material (3) for tripping the overload protector brings about an interruption in the electrical connection between the first contact (1) and the second contact (2) if a predetermined temperature value of the material (3) is exceeded, characterized in that the material is solder (3).

2. The overload protector of claim 1, characterized in that the first contact (1) and the second contact (2) are spaced apart from one another.

3. The overload protector of one of the foregoing claims, characterized in that the first contact (1) and the second contact (2) contact one another when they are electrically conductively connected.

4. The overload protector of one of the foregoing claims, characterized in that acting on the first contact (1) and/or on the second contact (2) is a force (F) that is oriented away from the respective other contact (1, 2).

5. The overload protector of one of the foregoing claims, characterized in that the force is generated by a spring element (4).

6. The overload protector of one of the foregoing characterized in that the first contact (1) and/or the second contact (2) is movably supported.

7. The overload protector of one of the foregoing claims, characterized in that the solder (3) is in contact with the first contact (1) and/or the second contact (2) when the first contact (1) and the second contact (2) are electrically conductively connected.

8. The overload protector of one of the foregoing claims, characterized in that the first contact (1) is disposed on a first arm (11), and/or the second contact (2) is disposed on a second arm (10).

9. The overload protector of one of the foregoing claims, characterized in that the first arm (11) and/or the second arm (10), in the non-tripped state of the overload protector, are kept by the action of the solder (3) in a position in which the first contact (1) and the second contact (2) are electrically connected.

10. The overload protector of one of the foregoing claims, characterized in that a first element (13) is associated with the first arm (11); that a second element (12) is associated with the second arm (10); and that the first element (13) and/or the second element (12), in the non-tripped state of the overload protector, is kept by the action of the solder in a position in which the first contact (1) and the second contact (2) are electrically connected.

11. The overload protector of one of the foregoing claims, characterized in that the first element (13) and the second element (12) are replaceable.

12. The overload protector of one of the foregoing claims, characterized in that a first line (15) is welded to the first contact (1), and/or that a second line (14) is welded to the second contact (2).

13. The overload protector of one of the foregoing claims, characterized in that the first arm (11) has a first opening (19), through which the first line (15) extends, and/or that the second arm (10) has a second opening (18), through which the second line (14) extends.

14. The overload protector of one of the foregoing claims, characterized in that the solder (3) is a soft solder.

15. The overload protector of one of the foregoing claims, characterized in that the solder (3) has a melting temperature of approximately 200° C.

16. The overload protector of one of the foregoing claims, characterized in that it trips at approximately 320° C.

17. An electrical machine, characterized in that it has an overload protector of one of the foregoing claims.

18. The electrical machine of claim 17, characterized in that the overload protector is disposed in the region of a commutator.

19. The electrical machine of claim 17 or 18, characterized in that the overload protector is disposed on a brush plate, which has brushes that cooperate with the commutator.

20. The electrical machine of one of claims 17-19, characterized in that the brushes include positive brushes, and that the overload protector is disposed at a connection bracket to which a power supply is connected that supplies the positive brushes.

21. The electrical machine of one of claims 17-19, characterized in that it is a starter or a starter-generator.

22. The use of a soldered point as the overload protector.
